(19) United States
(12) Patent Application Publication
(10) Pub. No.: US 2026/0160969 A1
(43) Pub. Date: Jun. 11, 2026

(54) RESIN COMPOSITION, OPTICAL FIBER, METHOD FOR PRODUCING OPTICAL FIBER, OPTICAL FIBER RIBBON, AND OPTICAL FIBER CABLE

(71) Applicant: SUMITOMO ELECTRIC INDUSTRIES, LTD., Osaka-shi, Osaka (JP)

(72) Inventor: Yuya HOMMA, Osaka-shi, Osaka (JP)

(21) Appl. No.: 18/723,607

(22) PCT Filed: May 1, 2024
(86) PCT No.: PCT/JP2024/016810

§ 371 Date: Jun. 24, 2024

(30) Foreign Application Priority Data
Jun. 1, 2023 (JP) 2023-090940

(51) Int. Cl. G02B 6/44; C03C 25/1065; C03C 25/285; C03C 25/50; C03C 25/6226

(52) U.S. Cl. CPC G02B 6/448; C03C 25/1065; C03C 25/285; C03C 25/50; C03C 25/6226; G02B 6/443; G02B 6/4434; G02B 6/4436; G02B 6/4486

(57) ABSTRACT

A resin composition for secondary coating of an optical fiber according to the present disclosure contains a photopolymerizable compound containing urethane (meth)acrylate derived from a plant component, and a photopolymerization initiator, and an optical fiber according to the present disclosure includes a glass fiber including a core and a clad, a primary resin layer covering the glass fiber in contact with the glass fiber, and a secondary resin layer covering the primary resin layer, in which the secondary resin layer contains a cured product of the resin composition.

### TECHNICAL FIELD

The present disclosure relates to a resin composition for secondary coating of an optical fiber, an optical fiber, a method for producing an optical fiber, an optical fiber ribbon, and an optical fiber cable.

This application claims priority based on Japanese Patent Application No. 2023-090940 filed on Jun. 1, 2023, and incorporates all the contents described in the Japanese patent application.

### BACKGROUND ART

In general, an optical fiber includes a coating resin layer for protecting a glass fiber that is an optical transmission medium. The coating resin layer, for example, is composed of two layers of a primary resin layer in contact with the glass fiber, and a secondary resin layer formed on the outer layer of the primary resin layer. For example, in Patent Literatures 1 to 5, a resin composition for secondary coating, containing a photopolymerizable compound such as urethane (meth)acrylate, is described.

### CITATION LIST

### Patent Literature

Patent Literature 1: JP 2012-57124 A
Patent Literature 2: JP 2005-255955 A
Patent Literature 3: JP 2004-161991 A
Patent Literature 4: JP 2010-510332 A
Patent Literature 5: JP 2005-89586 A

### SUMMARY OF INVENTION

A resin composition for secondary coating of an optical fiber according to one aspect of the present disclosure contains a photopolymerizable compound containing urethane (meth)acrylate derived from a plant component, and a photopolymerization initiator.

### BRIEF DESCRIPTION OF DRAWINGS

FIG. 1 is a schematic cross-sectional view illustrating an example of an optical fiber according to this embodiment.

FIG. 2 is a schematic cross-sectional view illustrating an optical fiber ribbon according to one embodiment.

FIG. 3 is a schematic cross-sectional view illustrating the optical fiber ribbon according to one embodiment.

FIG. 4 is a plan view illustrating an appearance of the optical fiber ribbon according to one embodiment.

FIG. 5 is a schematic cross-sectional view illustrating an optical fiber cable according to one embodiment.

FIG. 6 is a schematic cross-sectional view illustrating the optical fiber cable according to one embodiment.

### DESCRIPTION OF EMBODIMENTS

### Problems to be Resolved by Present Disclosure

Recently, activities for attaining sustainable development goals (SDGs) have been valued in each industry. As one of such activities, a contribution to a circulation-type society by the utilization of renewable resources has been required. One example of the renewable resources includes a biomass resource obtained by processing a raw material derived from a plant. Since the utilization of the biomass resource is considered to be important from the viewpoint of carbon neutrality, it is also required to form a coating resin layer using a resin composition with a high biomass degree in the field of an optical fiber. However, it is difficult to maintain the performance of the optical fiber such as a low-temperature characteristic and damage resistance by simply forming the coating resin layer using the raw material derived from a plant.

An object of the present disclosure is to provide a resin composition that has a high biomass degree and is capable of forming a resin layer suitable for the secondary coating of an optical fiber, and an optical fiber excellent in a low-temperature characteristic and damage resistance.

### Effects of Present Disclosure

According to the present disclosure, it is possible to provide the resin composition that has a high biomass degree and is capable of forming the resin layer suitable for the secondary coating of the optical fiber, and the optical fiber excellent in the low-temperature characteristic and the damage resistance.

### DESCRIPTION OF EMBODIMENTS OF PRESENT DISCLOSURE

First, the contents of embodiments of the present disclosure will be listed and described.
(1) A resin composition for secondary coating of an optical fiber according to one aspect of the present disclosure contains a photopolymerizable compound containing urethane (meth)acrylate derived from a plant component, and a photopolymerization initiator. Such a resin composition has a high biomass degree, is capable of forming a resin layer suitable for the secondary coating of the optical fiber, and is capable of improving the low-temperature characteristic and the damage resistance of the optical fiber.
(2) In (1) described above, from the viewpoint of further improving the low-temperature characteristic of the optical fiber, a biomass degree of the urethane (meth)acrylate may be 20% or more and 70% or less.
(3) In (1) or (2) described above, from the viewpoint of further improving the low-temperature characteristic of the optical fiber, a content of the urethane (meth)acrylate may be 10 parts by mass or more and 80 parts by mass or less on the basis of a total amount of 100 parts by mass of the resin composition.
(4) In any one of (1) to (3) described above, from the viewpoint of further increasing the biomass degree, the photopolymerizable compound further contains a monomer derived from a plant component.
(5) In (4) described above, from the viewpoint of imparting toughness suitable for a secondary resin layer, the monomer derived from a plant component may be at least one type selected from the group consisting of n-octyl (meth)acrylate, lauryl (meth)acrylate, isobornyl (meth)acrylate, tetrahydrofurfuryl (meth)acrylate, glycerine di(meth)acrylate, decanediol di(meth)acrylate, glycerine propylene oxide-modified tri(meth)acrylate, and glycerine tri(meth)acrylate.
(6) In any one of (1) to (5) described above, from the viewpoint of further improving the low-temperature characteristic and the damage resistance of the optical fiber, a biomass degree of the resin composition may be 10% or more and 50% or less.
(7) In any one of (1) to (6) described above, from the viewpoint of further improving the low-temperature characteristic of the optical fiber, a glass transition temperature of a resin film when curing the resin composition according to this embodiment with an ultraviolet ray in a condition of an integrated light intensity of 100 mJ/cm² and an illumination of 100 mW/cm² may be 60° C. or higher and 100° C. or lower.
(8) In (7) described above, from the viewpoint of improving the lateral pressure resistance and the damage resistance of the optical fiber, a Young's modulus of the resin film may be 600 MPa or more and 2000 MPa or less at 23° C.
(9) An optical fiber according to one aspect of the present disclosure includes a glass fiber including a core and a clad, a primary resin layer covering the glass fiber in contact with the glass fiber, and a secondary resin layer covering the primary resin layer, in which the secondary resin layer contains a cured product of the resin composition according to any one of (1) to (8) described above. Such an optical fiber is capable of contributing to carbon neutrality while having a low-temperature characteristic and damage resistance equivalent to or higher than those of the optical fiber of the related art.
(10) A method for producing an optical fiber according to one aspect of the present disclosure includes an applying step of applying the resin composition according to any one of (1) to (8) described above to an outer circumference of a glass fiber including a core and a clad, and a curing step of curing the resin composition by ultraviolet irradiation after the applying step. Accordingly, it is possible to produce an optical fiber excellent in a low-temperature characteristic and damage resistance.
(11) In an optical fiber ribbon according to one aspect of the present disclosure, a plurality of the optical fibers according to (9) described above are arranged in parallel and coated with a ribbon resin. Such an optical fiber ribbon is excellent in a low-temperature characteristic, and can be filled in an optical fiber cable with a high density.
(12) In an optical fiber cable according to one aspect of the present disclosure, the optical fiber ribbon according to (11) described above is stored in a cable. The optical fiber cable including such an optical fiber ribbon is excellent in a low-temperature characteristic.
(13) In an optical fiber cable according to one aspect of the present disclosure, a plurality of the optical fibers according to (9) described above are stored in a cable. Such an optical fiber cable is excellent in a low-temperature characteristic.

### DETAILS OF EMBODIMENTS OF PRESENT DISCLOSURE

Specific examples of a resin composition and an optical fiber according to this embodiment will be described with reference to the drawings as necessary. Note that, the present disclosure is not limited to such examples, but is indicated by claims, and is intended to include the meaning equivalent to claims and all changes within claims. In the following description, the same reference numerals will be applied to the same constituents in the description of the drawings, and repeated description will be omitted. In this specification, (meth)acrylate indicates acrylate or methacrylate corresponding thereto, and the same applies to other similar expressions such as (meth)acryloyl. In addition, PO modification indicates propylene oxide modification, and EO modification indicates ethylene oxide modification. Note that, in this specification, ppm indicates a mass ratio.

In this specification, a biomass degree indicates % by mass derived from a plant component (a component derived from a biomass) in the resin composition or in a raw material. For example, in a case where there is a raw material A with a molecular weight of 100, and a molecular weight derived from a plant is 70 and a molecular weight derived from petroleum is 30, the biomass degree of the raw material A is 70%. In addition, the biomass degree of a resin composition containing 60 g of a raw material B with a biomass degree of 30% and 40 g of a raw material C with a biomass degree of 50% is (60 g×30%+40 g×50%)/(60 g+40 g)=38%.

### (Resin Composition)

A resin composition for secondary coating of the optical fiber according to this embodiment contains a photopolymerizable compound containing urethane (meth)acrylate derived from a plant component, and a photopolymerization initiator. The urethane (meth)acrylate derived from a plant component (hereinafter, referred to as “urethane (meth)acrylate (A)”) is urethane (meth)acrylate synthesized by using a raw material derived from a plant. By using the urethane (meth)acrylate (A), it is possible to form a resin layer with a high biomass degree, and improve the low-temperature characteristic and the damage resistance of the optical fiber.

The biomass degree of the resin composition according to this embodiment, from the viewpoint of further improving the low-temperature characteristic and the damage resistance of the optical fiber, may be 10% or more and 50% or less, 15% or more and 50% or less, 20% or more and 50% or less, or 25% or more and 50% or less.

The biomass degree of the urethane (meth)acrylate (A), from the viewpoint of further increasing the biomass degree of the resin composition, may be 20% or more and 70% or less, 25% or more and 65% or less, 30% or more and 60% or less, 35% or more and 55% or less, or 40% or more and 50% or less.

In general, the urethane (meth)acrylate can be obtained by a reaction between polyol, polyisocyanate, and hydroxyl group-containing (meth)acrylate (or isocyanate group-containing (meth)acrylate). The polyol includes polyol derived from a plant and polyol derived from petroleum, and the polyisocyanate includes polyisocyanate derived from a plant and polyisocyanate derived from petroleum.

The urethane (meth)acrylate (A) can be synthesized by using at least one of the polyol derived from a plant and the polyisocyanate derived from a plant, as the raw material. When the urethane (meth)acrylate (A) is synthesized, the polyol derived from a plant and the polyol derived from petroleum may be used together, or the polyisocyanate derived from a plant and the polyisocyanate derived from petroleum may be used together.

Examples of the polyol derived from a plant include polyester polyol derived from a plant, polyether polyol derived from a plant, polycarbonate polyol derived from a plant, soybean oil-modified polyol, castor oil-modified polyol, algae-derived polyol, and cardanol polyol.

Examples of the polyester polyol derived from a plant include polyester polyol having a structure derived from a dimer acid, polyester polyol having a structure derived from 1,3-propanediol, and polyester polyol using a sebacic acid derived from castor oil.

Examples of the polyether polyol derived from a plant include polyether polyol obtained by the ring-opening polymerization of tetrahydrofuran, polyether polyol obtained by copolymerization between tetrahydrofuran and 2-methyl tetrahydrofuran, and polyether polyol obtained by the polymerization of 1,3-propanediol.

Examples of the polycarbonate polyol derived from a plant include polycarbonate polyol derived from isosorbide, and polycarbonate polyol having a structure derived from 1,10-decanediol.

Examples of the polyol derived from petroleum include polyethylene glycol (PEG), polypropylene glycol (PPG), a block copolymer of PEG-PPG-PEG, polycarbonate diol, polybutadienediol, and bisphenol A/ethylene oxide-addition diol.

Examples of the polyisocyanate derived from a plant include 1,5-pentamethylene diisocyanate, dimer acid diisocyanate, lysine diisocyanate, lysine triisocyanate, octamethylene diisocyanate, and decamethylene diisocyanate.

Examples of the polyisocyanate derived from petroleum include 2,4-tolylene diisocyanate, 2,6-tolylene diisocyanate, isophorone diisocyanate, dicyclohexyl methane diisocyanate, diphenyl methane diisocyanate, hexamethylene diisocyanate, xylene diisocyanate, hydrogenated xylene diisocyanate, 1,5-naphthalene diisocyanate, norbornene diisocyanate, tetramethyl xylene diisocyanate, and trimethyl hexamethylene diisocyanate.

Examples of the hydroxyl group-containing (meth)acrylate include 2-hydroxyethyl (meth)acrylate, 2-hydroxypropyl (meth)acrylate, 2-hydroxybutyl (meth)acrylate, caprolactone (meth)acrylate, 2-hydroxy-3-phenoxypropyl (meth)acrylate, 2-(meth)acryloyloxyethyl-2-hydroxyethyl phthalate, 2-hydroxy-o-phenyl phenol propyl (meth)acrylate, 2-hydroxy-3-methacryl propyl acrylate, trimethylol propane di(meth)acrylate, and pentaerythritol tri(meth)acrylate.

The urethane (meth)acrylate (A) may have 2 or more, 3 or more, or 4 or more (meth)acryloyl groups that are a photopolymerizable functional group. The number of functional groups of the urethane (meth)acrylate (A) may be 2 or 3.

The number average molecular weight (Mn) of the urethane (meth)acrylate (A) may be 500 or more and 10000 or less, 1000 or more and 9000 or less, 1500 or more and 8000 or less, 2000 or more and 7000 or less, or 2500 or more and 5000 or less. The weight average molecular weight (Mw) of the urethane (meth)acrylate (A) may be 1000 or more and 20000 or less, 1500 or more and 10000 or less, 2000 or more and 8000 or less, 2500 or more and 7000 or less, or 3000 or more and 6000 or less.

The glass transition temperature (Tg) of a homopolymer of the urethane (meth)acrylate (A) may be 0° C. or higher, 20° C. or higher, or 40° C. or higher, and may be 100° C. or lower, 80° C. or lower, or 70° C. or lower. Tg can be measured by a dynamic viscoelasticity test of the homopolymer.

Examples of a commercially available product of the urethane (meth)acrylate (A) include SARBIO 7300NS, SARBIO 7302NS, SARBIO 7403NS, SARBIO 7404NS, SARBIO 7405NS, and SARBIO 7406NS, manufactured by Arkema S.A., UFB-C01 and UFB-0146, manufactured by Kyoeisha Chemical Co., Ltd., UT-8166, UT-8200, UT-7792, and UT-7999, manufactured by Mitsubishi Chemical Corporation, and 8UX-2017A, manufactured by Taisei Fine Chemical Co., Ltd.

The content of the urethane (meth)acrylate (A), from the viewpoint of further improving the low-temperature characteristic of the optical fiber, may be 10 parts by mass or more and 80 parts by mass or less, 10 parts by mass or more and 75 parts by mass or less, 15 parts by mass or more and 70 parts by mass or less, or 20 parts by mass or more and 60 parts by mass or less, on the basis of the total amount of 100 parts by mass of the resin composition.

The resin composition according to this embodiment may further contain urethane (meth)acrylate derived from a petroleum component (hereinafter, referred to as “urethane (meth)acrylate (B)”). The urethane (meth)acrylate (B) is urethane (meth)acrylate not using the raw material derived from a plant. As the urethane (meth)acrylate (B), for example, a reactant of the polyol derived from petroleum, the polyisocyanate derived from petroleum, and the hydroxyl group-containing (meth)acrylate can be used.

From the viewpoint of obtaining a Young's modulus suitable for a secondary resin layer, the number average molecular weight (Mn) of the polyol derived from petroleum used for the synthesis of the urethane (meth)acrylate (B) may be 300 or more and 2500 or less, 500 or more and 2000 or less, or 800 or more and 1500 or less.

Mn of the urethane (meth)acrylate (B), from the viewpoint of obtaining the Young's modulus suitable for the secondary resin layer, may be 500 or more and 10000 or less, 1000 or more and 9000 or less, 1500 or more and 8000 or less, or 2000 or more and 7000 or less. Mw of the urethane (meth)acrylate (B) may be 1000 or more and 20000 or less, 1500 or more and 10000 or less, 2000 or more and 8000 or less, or 2500 or more and 7000 or less.

Mn and Mw of the urethane (meth)acrylate (A) and the urethane (meth)acrylate (B) can be measured by gel permeation chromatography (GPC).

As a catalyst when synthesizing the urethane (meth)acrylate (A) and the urethane (meth)acrylate (B), for example, an organic tin compound can be used. Examples of the organic tin compound include dibutyl tin dilaurate, dibutyl tin diacetate, dibutyl tin malate, dibutyl tin bis(2-ethyl hexyl mercaptoacetate), dibutyl tin bis(isooctyl mercaptoacetate), and dibutyl tin oxide.

When the urethane (meth)acrylate (A) and the urethane (meth)acrylate (B) are synthesized, 4-methoxyphenol or 2,6-di-tert-butyl-p-cresol may be added as a polymerization inhibitor.

The resin composition according to this embodiment may further contain a photopolymerizable compound (hereinafter, referred to as a “monomer”) other than the urethane (meth)acrylate (A) and the urethane (meth)acrylate (B), as the photopolymerizable compound. The monomer can be distinguished from the urethane (meth)acrylate from the viewpoint that the monomer does not have a urethane bond. Examples of the monomer include (meth)acrylic acid ester, a N-vinyl compound, a (meth)acrylamide compound, and epoxy (meth)acrylate. The monomer may be a monofunctional monomer having one photopolymerizable ethylenically unsaturated group, or may be a polyfunctional monomer having two or more ethylenically unsaturated groups.

Examples of monofunctional (meth)acrylic acid ester include methyl (meth)acrylate, ethyl (meth)acrylate, propyl (meth)acrylate, n-butyl (meth)acrylate, s-butyl (meth)acrylate, t-butyl (meth)acrylate, isobutyl (meth)acrylate, n-pentyl (meth)acrylate, isopentyl (meth)acrylate, hexyl (meth)acrylate, heptyl (meth)acrylate, 2-ethyl hexyl (meth)acrylate, isooctyl (meth)acrylate, isodecyl (meth)acrylate, phenoxyethyl (meth)acrylate, benzyl (meth)acrylate, cyclic trimethylol propane formal acrylate, dicyclopentenyl (meth)acrylate, dicyclopentenyl oxyethyl (meth)acrylate, dicyclopentanyl (meth)acrylate, methoxypolyethylene glycol (meth)acrylate, butoxypolyethylene glycol (meth)acrylate, nonyl phenol polyethylene glycol (meth)acrylate, nonyl phenoxypolyethylene glycol (meth)acrylate, 3-phenoxybenzyl (meth)acrylate, methyl phenoxyethyl (meth)acrylate, phenoxydiethylene glycol (meth)acrylate, phenoxypolyethylene glycol (meth)acrylate, m-phenoxybenzyl (meth)acrylate, 2-(2-ethoxyethoxy)ethyl (meth)acrylate, 2-hydroxy-3-phenoxypropyl acrylate, carboxyethyl (meth)acrylate, carboxypentyl (meth)acrylate, and ω-carboxy-polycaprolactone (meth)acrylate.

Examples of polyfunctional (meth)acrylic acid ester include a difunctional monomer such as ethylene glycol di(meth)acrylate, polyethylene glycol di(meth)acrylate, polypropylene glycol di(meth)acrylate, neopentyl glycol di(meth)acrylate, tripropylene glycol di(meth)acrylate, triethylene glycol di(meth)acrylate, cyclohexane dimethanol di(meth)acrylate, dipropylene glycol di(meth)acrylate, tetraethylene glycol di(meth)acrylate, neopentyl glycol hydroxypivalate di(meth)acrylate, 1,3-butylene glycol di(meth)acrylate, 1,4-butanediol di(meth)acrylate, diethylene glycol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyl diol di(meth)acrylate, 3-ethyl-1,8-octanediol di(meth)acrylate, tricyclodecanol di(meth)acrylate, 9,9-bis[4-(2-hydroxyethoxy)phenyl] fluorene di(meth)acrylate, bisphenol A epoxy di(meth)acrylate, bisphenol F epoxy di(meth)acrylate, EO adduct di(meth)acrylate of bisphenol A, EO adduct di(meth)acrylate of bisphenol F, PO adduct di(meth)acrylate of bisphenol A, and PO adduct di(meth)acrylate of bisphenol F; and a trifunctional or higher monomer such as trimethylol propane tri(meth)acrylate, trimethylol octane tri(meth)acrylate, trimethylol propane polyethoxytri(meth)acrylate, trimethylol propane polypropoxytri(meth)acrylate, trimethylol propane polyethoxypolypropoxytri(meth)acrylate, tris[(meth)acryloyl oxyethyl] isocyanurate, pentaerythritol tri(meth)acrylate, pentaerythritol polyethoxytetra(meth)acrylate, pentaerythritol polypropoxytetra(meth)acrylate, pentaerythritol tetra(meth)acrylate, ditrimethylol propane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyl oxyethyl] isocyanurate.

Examples of the (meth)acrylamide compound include dimethyl (meth)acrylamide, diethyl (meth)acrylamide, (meth)acryloyl morpholine, hydroxymethyl (meth)acrylamide, hydroxyethyl (meth)acrylamide, isopropyl (meth)acrylamide, dimethyl aminopropyl (meth)acrylamide, a dimethyl aminopropyl acrylamide/methyl chloride salt, diacetone acrylamide, (meth)acryloyl piperidine, (meth)acryloyl pyrrolidine, (meth)acrylamide, N-hexyl (meth)acrylamide, N-methyl (meth)acrylamide, N-butyl (meth)acrylamide, N-methylol (meth)acrylamide, and N-methylol propane (meth)acrylamide.

Examples of the N-vinyl compound include N-vinyl pyrrolidone, N-vinyl caprolactam, N-vinyl methyl oxazolidinone, N-vinyl imidazole, and N-vinyl-N-methyl acetamide.

As the epoxy (meth)acrylate, for example, a reactant of a diglycidyl ether compound having a bisphenol skeleton and a compound having a (meth)acryloyl group such as a (meth)acrylic acid can be used.

In order to further increase the biomass degree of the resin composition, a monomer derived from a plant component may be used as the monomer. The biomass degree of the monomer derived from a plant component, from the viewpoint of further increasing the biomass degree of the resin composition, may be 15% or more and 75% or less, 18% or more and 72% or less, or 20% or more and 70% or less.

Examples of the monomer derived from a plant component include n-octyl (meth)acrylate, lauryl (meth)acrylate, stearyl (meth)acrylate, isobornyl (meth)acrylate, tetrahydrofurfuryl (meth)acrylate, isoamyl (meth)acrylate, glycerine carbonate (meth)acrylate, glycerine di(meth)acrylate, decanediol di(meth)acrylate, glycerine tri(meth)acrylate, glycerine PO-modified tri(meth)acrylate, diglycerine EO-modified tetra(meth)acrylate, polyglycerine hexa(meth)acrylate, and sorbitol EO-modified hexa(meth)acrylate.

From the viewpoint of easily adjusting the Young's modulus or Tg of the resin layer, at least one type selected from the group consisting of n-octyl (meth)acrylate, lauryl (meth)acrylate, isobornyl (meth)acrylate, tetrahydrofurfuryl (meth)acrylate, glycerine di(meth)acrylate, decanediol di(meth)acrylate, glycerine PO-modified tri(meth)acrylate, and glycerine tri(meth)acrylate may be used as the monomer derived from a plant component.

The content of the monomer derived from a plant component may be 10 parts by mass or more and 60 parts by mass or less, 10 parts by mass or more and 55 parts by mass or less, or 15 parts by mass or more and 50 parts by mass or less, on the basis of the total amount of 100 parts by mass of the resin composition.

The photopolymerization initiator can be used by being suitably selected from known radical photopolymerization initiators. Examples of the photopolymerization initiator include 1-hydroxycyclohexyl phenyl ketone (Omnirad 184, manufactured by IGM Resins B.V.), 2,2-dimethoxy-2-phenyl acetophenone (Omnirad 651, manufactured by IGM Resins B.V.), 2,4,6-trimethyl benzoyl diphenyl phosphine oxide (Omnirad TPO, manufactured by IGM Resins B.V.), ethyl (2,4,6-trimethyl benzoyl)-phenyl phosphinate (Omnirad TPO-L, manufactured by IGM Resins B.V.), 2-benzyl-2-dimethyl amino-4′-morpholinobutyrophenone (Omnirad 369, manufactured by IGM Resins B.V.), 2-dimethyl amino-2-(4-methyl-benzyl)-1-(4-morpholin-4-yl-phenyl)-butan-1-one (Omnirad 379, manufactured by IGM Resins B.V.), bis(2,4,6-trimethyl benzoyl) phenyl phosphine oxide (Omnirad 819, manufactured by IGM Resins B.V.), and 2-methyl-1-[4-(methyl thio) phenyl]-2-morpholinopropan-1-one (Omnirad 907, manufactured by IGM Resins B.V.).

Two or more types of photopolymerization initiators may be used by being mixed. The photopolymerization initiator may contain 2,4,6-trimethyl benzoyl diphenyl phosphine oxide from the viewpoint of being excellent in the rapid curability of the resin composition.

The content of the photopolymerization initiator may be 0.1 parts by mass or more and 5 parts by mass or less, 0.3 parts by mass or more and 4 parts by mass or less, or 0.4 parts by mass or more and 3 parts by mass or less, on the basis of the total amount of 100 parts by mass of the resin composition.

The resin composition according to this embodiment may further contain a sensitizer, a photo-acid-generating agent, a leveling agent, an antifoaming agent, an antioxidant, an ultraviolet absorber, and the like.

Examples of the sensitizer include an anthracene compound such as 9,10-dibutoxyanthracene, 9,10-diethoxyanthracene, 9,10-dipropoxyanthracene, and 9,10-bis(2-ethyl hexyl oxy) anthracene, a thioxantone compound such as 2,4-diethyl thioxantone, 2,4-diethyl thioxanthen-9-one, 2-isopropyl thioxantone, and 4-isopropyl thioxantone, an amine compound such as triethanol amine, methyl diethanol amine, and triisopropanol amine, a benzoin compound, an anthraquinone compound, a ketal compound, and a benzophenone compound.

As the photo-acid-generating agent, an onium salt having a A⁺B⁻ structure may be used. Examples of the photo-acid-generating agent include a sulfonium salt such as CPI-100P, CPI-101A, CPI-110P, CPI-200K, CPI-210S, CPI-310B, and CPI-410S (manufactured by San-Apro Ltd.), and Omnicat 270 and Omnicat 290 (manufactured by IGM Resins B.V.), and an iodonium salt such as CPI-IK-1 (manufactured by San-Apro Ltd.), Omnicat 250 (manufactured by IGM Resins B.V.), and WPI-113, WPI-116, WPI-124, WPI-169, and WPI-170 (manufactured by FUJIFILM Wako Pure Chemical Corporation).

The viscosity of the resin composition according to this embodiment at 25° C., from the viewpoint of applicability, may be 0.5 Pa·s or more and 20 Pads or less, 0.8 Pa·s or more and 18 Pa·s or less, or 1 Pa·s or more and 10 Pas or less. The viscosity of the resin composition at 25° C. can be measured by using a rheometer (“MCR-102”, manufactured by Anton Paar GmbH) in a condition of a cone plate CP25-2 and a shear rate of 10 s⁻¹.

From the viewpoint of improving the low-temperature characteristic of the optical fiber, Tg of a resin film when curing the resin composition with an ultraviolet ray in a condition of an integrated light intensity of 100 mJ/cm² and an illumination of 100 m W/cm² may be 60° C. or higher and 100° C. or lower, 65° C. or higher and 99° C. or lower, 68° C. or higher and 98° C. or lower, or 70° C. or higher and 98° C. or lower.

From the viewpoint of improving the lateral pressure resistance and the damage resistance of the optical fiber, the Young's modulus of the resin film when curing the resin composition with an ultraviolet ray in a condition of an integrated light intensity of 100 mJ/cm² and an illumination of 100 mW/cm² may be 600 MPa or more and 3000 MPa or less, 650 MPa or more and 2000 MPa or less, or 700 MPa or more and 1300 MPa or less at 23° C.

### (Optical Fiber)

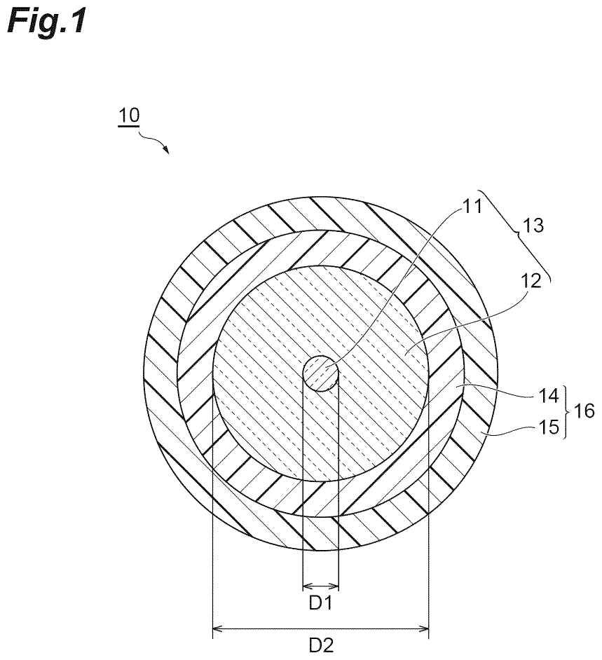

FIG. 1 is a schematic cross-sectional view illustrating an example of the optical fiber according to this embodiment. An optical fiber 10 includes a glass fiber 13 including a core 11 and a clad 12, and a coating resin layer 16 including a primary resin layer 14 and a secondary resin layer 15 provided on the outer circumference of the glass fiber 13.

The clad 12 surrounds the core 11. The core 11 and the clad 12 mainly contain glass such as quartz glass, and for example, quartz glass to which germanium is added or pure quartz glass can be used for the core 11, and pure quartz glass or quartz glass to which fluorine is added can be used for the clad 12.

In FIG. 1, for example, the outer diameter (D2) of the glass fiber 13 is approximately 100 to 125 μm, and the diameter (D1) of the core 11 configuring the glass fiber 13 is approximately 7 to 15 μm. In general, the thickness of the coating resin layer 16 is approximately 22 to 70 μm. The thickness of each of the primary resin layer 14 and the secondary resin layer 15 may be approximately 5 to 50 μm.

In a case where the outer diameter of the glass fiber 13 is approximately 125 μm, and the thickness of the coating resin layer 16 is 60 μm or more and 70 μm or less, the thickness of each of the primary resin layer 14 and the secondary resin layer 15 may be approximately 10 to 50 μm, and for example, the thickness of the primary resin layer 14 may be 35 μm and the thickness of the secondary resin layer 15 may be 25 μm. The outer diameter of the optical fiber 10 may be approximately 245 to 265 μm.

In a case where the outer diameter of the glass fiber 13 is approximately 125 μm, and the thickness of the coating resin layer 16 is 20 μm or more and 48 μm or less, the thickness of each of the primary resin layer 14 and the secondary resin layer 15 may be approximately 8 to 38 μm, and for example, the thickness of the primary resin layer 14 may be 25 μm and the thickness of the secondary resin layer 15 may be 10 μm. The outer diameter of the optical fiber 10 may be approximately 165 to 221 μm.

In a case where the outer diameter of the glass fiber 13 is approximately 100 μm, and the thickness of the coating resin layer 16 is 22 μm or more and 37 μm or less, the thickness of each of the primary resin layer 14 and the secondary resin layer 15 may be approximately 5 to 32 μm, and for example, the thickness of the primary resin layer 14 may be 25 μm and the thickness of the secondary resin layer 15 may be 10 μm. The outer diameter of the optical fiber 10 may be approximately 144 to 174 μm.

By applying the resin composition according to this embodiment to the secondary resin layer, it is possible to produce the optical fiber excellent in the low-temperature characteristic while increasing the biomass degree.

A method for producing an optical fiber according to this embodiment includes an applying step of applying the resin composition to the outer circumference of the glass fiber including the core and the clad, and a curing step of curing the resin composition by ultraviolet irradiation after the applying step.

The primary resin layer 14, for example, can be formed by curing a resin composition containing a photopolymerizable compound containing urethane (meth)acrylate, a photopolymerization initiator, a silane coupling agent, and the like. The resin composition for forming the primary resin layer has a composition different from that of the resin composition for secondary coating. The resin composition for primary coating can be prepared by using a known technology of the related art.

The Young's modulus of the primary resin layer, from the viewpoint of improving the microbending resistance of the optical fiber, may be 0.80 MPa or less, 0.70 MPa or less, 0.60 MPa or less, or 0.50 MPa or less at 23±2° C. In a case where the Young's modulus of the primary resin layer is greater than 0.80 MPa, an external force is easily transmitted to the glass fiber, and a transmission loss due to microbending may increase. The Young's modulus of the primary resin layer, from the viewpoint of improving the low-temperature characteristic of the optical fiber, may be 0.10 MPa or more, 0.15 MPa or more, or 0.20 MPa or more at 23±2° C.

The Young's modulus of the primary resin layer can be measured by a pullout modulus (POM) method at 23° C. Two parts of the optical fiber are fixed with two chucks, the portion of the coating resin layer (the primary resin layer and the secondary resin layer) between two chucks is removed, and then, one chuck is fixed, and the other chuck is gently moved in a direction opposite to the fixed chuck. In a case where the length of the portion of the optical fiber that is interposed by the moved chuck is set to L, the movement amount of the chuck is set to Z, the outer diameter of the primary resin layer is set to Dp, the outer diameter of the glass fiber is set to Df, the Poisson's ratio of the primary resin layer is set to n, and a load when moving the chuck is set to W, the Young's modulus of the primary resin layer can be obtained from the following equation.

Young's Modulus (MPa)=((1+n)W/πLZ)×ln(Dp/Df)

From the viewpoint of improving the microbending resistance of the optical fiber, the Young's modulus of the secondary resin layer may be 600 MPa or more, 700 MPa or more, or 800 MPa or more at 23±2° C. The upper limit value of the Young's modulus of the secondary resin layer is not particularly limited, but from the viewpoint of imparting toughness suitable for the secondary resin layer, may be 3000 MPa or less, 2500 MPa or less, or 2000 MPa or less at 23±2° C.

The Young's modulus of the secondary resin layer can be measured by the following method. First, the optical fiber is immersed in a mixed solvent of acetone and ethanol, and only the coating resin layer is extracted into the shape of a cylinder. In this case, since the primary resin layer and the secondary resin layer are integrated, but the Young's modulus of the primary resin layer is 1/10000 or more and 1/1000 or less of the Young's modulus of the secondary resin layer, the Young's modulus of the primary resin layer can be ignored. Next, the solvent is removed from the coating resin layer by vacuum drying, and then, a tension test (a tension rate is 1 mm/minute) is performed at 23° C., and the Young's modulus can be obtained by a secant equation at a strain of 2.5%.

In the method for producing an optical fiber according to this embodiment, by using the resin composition according to this embodiment as the resin composition for secondary coating, it is possible to produce the optical fiber that has a high biomass degree and is excellent in the low-temperature characteristic.

### (Optical Fiber Ribbon)

It is possible to produce an optical fiber ribbon by using the optical fiber according to this embodiment. In the optical fiber ribbon, a plurality of optical fibers are arranged in parallel, and are coated with a ribbon resin.

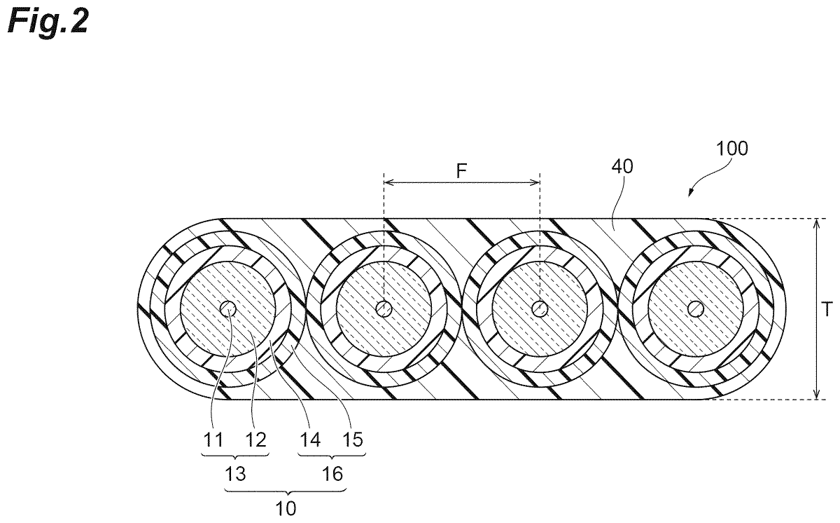

FIG. 2 is a schematic cross-sectional view illustrating an optical fiber ribbon according to one embodiment. An optical fiber ribbon 100 includes a plurality of optical fibers 10, and a connecting resin layer 40 in which the optical fibers 10 are connected by being (integrally) coated with the ribbon resin. In FIG. 2, as an example, four optical fibers 10 are illustrated, but the number of optical fibers is not particularly limited.

The optical fibers 10 may be integrated in the state of being arranged in parallel in contact with each other, or some or all of the optical fibers 10 may be integrated in the state of being arranged in parallel at a regular interval. A center-to-center distance F between the adjacent optical fibers 10 may be 220 μm or more and 280 μm or less. In a case where the center-to-center distance is set to 220 μm or more and 280 μm or less, it is possible to easily place the optical fiber in the existing V-shaped groove, and obtain the optical fiber ribbon excellent in collective fusion properties. A thickness T of the optical fiber ribbon 100 depends on the outer diameter of the optical fiber 10, and may be 164 μm or more and 285 μm or less.

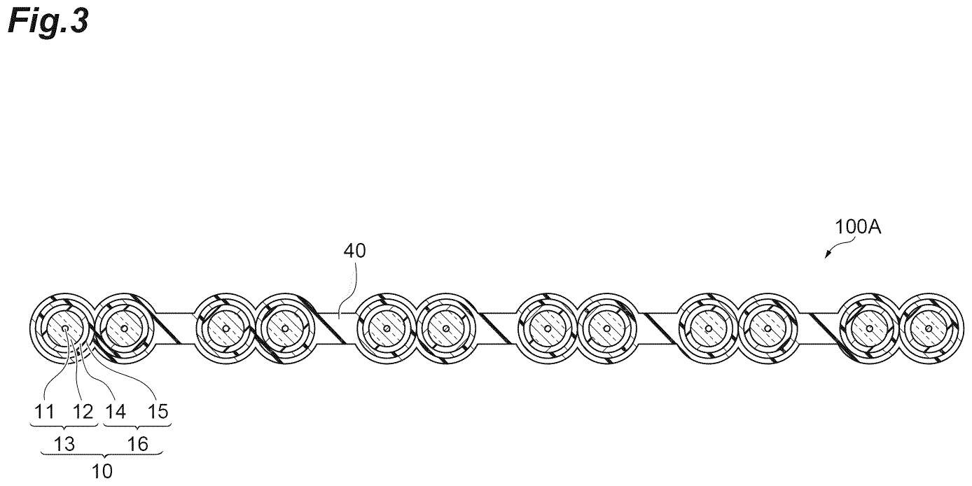

FIG. 3 is a schematic cross-sectional view illustrating an example of the optical fiber ribbon in which the optical fibers are integrated in the state of being arranged in parallel at a regular interval. In an optical fiber ribbon 100A illustrated in FIG. 3, two optical fibers 10 are connected with the ribbon resin at a regular interval such that 12 optical fibers are connected. The ribbon resin forms the connecting resin layer 40.

As the ribbon resin, a resin material generally known as a ribbon material can be used. The ribbon resin, from the viewpoint of the damage prevention properties, the ease of separation, or the like of the optical fiber 10, may contain a thermosetting resin such as a silicone resin, an epoxy resin, and a urethane resin, or an ultraviolet curable resin such as epoxy acrylate, urethane acrylate, and polyester acrylate.

In a case where the optical fibers 10 are arranged in parallel at a regular interval, that is, the adjacent optical fibers 10 are joined via the ribbon resin without being in contact with each other, the thickness of the connected portion at the center between the optical fibers 10 may be 150 μm or more and 220 μm or less. Since the optical fiber ribbon is easily deformed when stored in a cable, the optical fiber ribbon may have a dent in the connected portion of the optical fibers. The dent may be formed in the shape of a triangle with a narrow angle on one surface side of the connected portion.

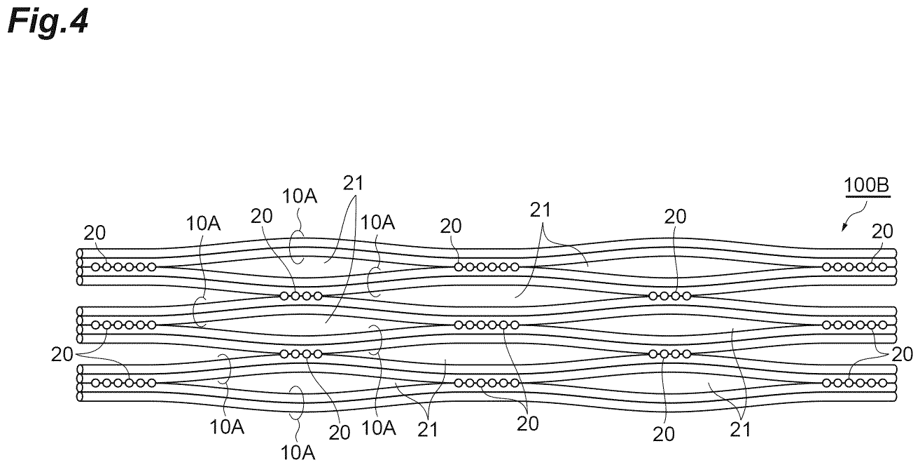

The optical fiber ribbon according to this embodiment may have a connected portion and an unconnected portion intermittently in a longitudinal direction and a width direction. FIG. 4 is a plan view illustrating the appearance of the optical fiber ribbon according to one embodiment. An optical fiber ribbon 100B includes a plurality of optical fibers, a plurality of connected portions 20, and unconnected portions (separated portions) 21. The unconnected portion 21 is intermittently formed in the longitudinal direction of the optical fiber ribbon. The optical fiber ribbon 100B is an intermittently connected optical fiber ribbon in which the connected portion 20 and the unconnected portion 21 are intermittently provided in the longitudinal direction for every two optical fibers 10A. The “connected portion” indicates a portion in which the adjacent optical fibers are integrated via the connecting resin layer, and the “unconnected portion” indicates a portion in which the adjacent optical fibers are not integrated via the connecting resin layer but there is a gap between the optical fibers.

Since the unconnected portion 21 is intermittently provided in the connected portions 20 provided for every two optical fibers in the optical fiber ribbon having the configuration described above, the optical fiber ribbon is easily deformed. Accordingly, when the optical fiber ribbon is mounted on an optical fiber cable, since the optical fiber ribbon can be mounted by being easily rolled up, it is possible to make the optical fiber ribbon suitable for high-density mounting. In addition, since it is possible to easily tear the connected portion 20 using the unconnected portion 21 as a starting point, the single-core separation of the optical fiber 10 in the optical fiber ribbon is facilitated.

By using the optical fiber described above, the optical fiber ribbon according to this embodiment has a high biomass degree, is excellent in the low-temperature characteristic, and can be filled in the optical fiber cable with a high density.

### (Optical Fiber Cable)

In an optical fiber cable according to this embodiment, the optical fiber ribbon is stored in a cable. Examples of the optical fiber cable include a slot-type optical fiber cable having a plurality of slots (grooves). In the slot, the optical fiber ribbon can be mounted such that a mounting density in each slot is approximately 25% to 65%. The mounting density indicates a ratio of the cross-sectional area of the optical fiber ribbon mounted in the slot to the cross-sectional area of the slot. The optical fiber cable according to this embodiment may have a configuration in which the plurality of optical fibers are stored in the cable without being coated with the ribbon resin.

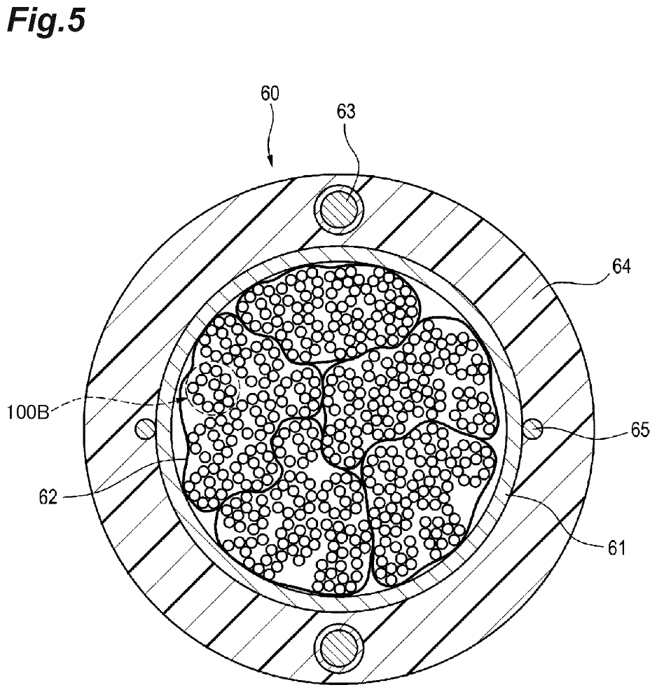

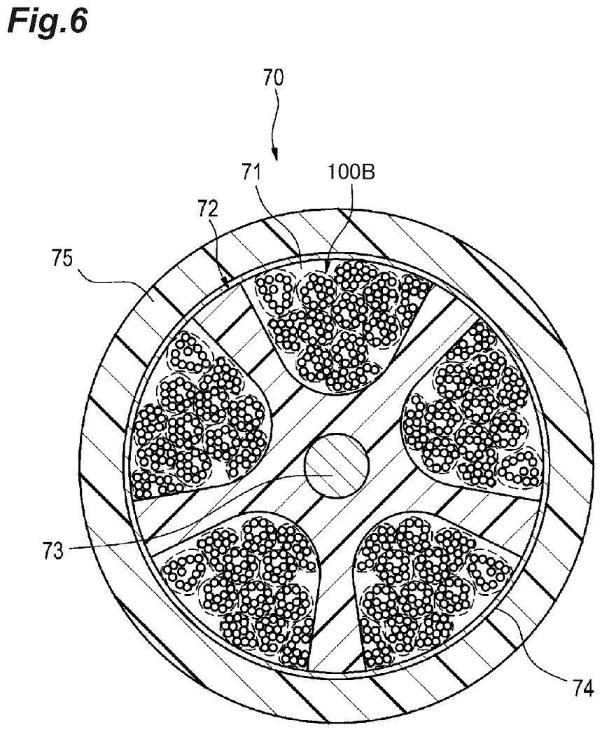

An example of the optical fiber cable according to this embodiment will be described with reference to FIGS. 5 and 6. In FIGS. 5 and 6, the intermittently connected optical fiber ribbon is stored, but the plurality of optical fibers not coated with the ribbon resin may be stored in the state of being bundled.

FIG. 5 is a schematic cross-sectional view of a slotless optical fiber cable 60 using the intermittently connected optical fiber ribbon 100B described above. The optical fiber cable 60 includes a cylindrical tube 61 and a plurality of optical fiber ribbons 100B. The plurality of optical fiber ribbons 100B may be bundled with an intervention 62 such as aramid fiber. In addition, the plurality of optical fiber ribbons 100B may have markings different from each other. The optical fiber cable 60 has a structure in which the plurality of bundled optical fiber ribbons 100B are intertwined, and a resin to be the tube 61 is extruded around the optical fiber ribbons and covered with an external coat 64 together with a tension member 63. In a case where waterproof properties are required, water-absorption yarns may be inserted inside the tube 61. The tube 61, for example, can be formed by using a resin such as polybutylene terephthalate and high-density polyethylene. A tear string 65 may be provided outside the tube 61.

FIG. 6 is a schematic cross-sectional view of a slot-type optical fiber cable 70 using the intermittently connected optical fiber ribbon 100B described above. The optical fiber cable 70 includes a slot rod 72 including a plurality of slots 71, and the plurality of optical fiber ribbons 100B. The optical fiber cable 70 has a structure in which the plurality of slots 71 are radially provided in the slot rod 72 including a tension member 73 at the center. The plurality of slots 71 may be provided by being twisted spirally or in the shape of SZ in the longitudinal direction of the optical fiber cable 70. In each of the slots 71, the plurality of optical fiber ribbons 100B, which are in a dense state from a state where the optical fiber ribbons are arranged in parallel, are stored. Each of the optical fiber ribbons 100B may be bundled with a bundle material for identification. A wrapping tape 74 is wound around the slot rod 72, and an external coat 75 is formed around the wrapping tape 74. The external coats 64 and 75, for example, can be formed by using a resin such as polyvinyl chloride and polyethylene.

The optical fiber cable including the optical fiber or the optical fiber ribbon according to this embodiment has a high biomass degree and is excellent in the low-temperature characteristic.

### EXAMPLES

Hereinafter, the present disclosure will be described in more detail by results of evaluation tests using Examples and Comparative Examples according to the present disclosure. Note that, the present disclosure is not limited to Examples.

### [Synthesize of Urethane Acrylate]

### (B-1)

Polypropylene glycol with Mn of 1000 (manufactured by Sanyo Chemical Industries, Ltd., product name “SANNIX PP-1000”) and 2,4-tolylene diisocyanate (TDI) were put in a reaction tank such that a molar ratio (NCO/OH) of NCO and OH was 2.0. Subsequently, as a catalyst, 200 μm of dibutyl tin dilaurate was added with respect to the final total preparation amount, and as a polymerization inhibitor, 500 ppm of 2,6-di-tert-butyl-p-cresol (BHT) was added with respect to the final total preparation amount. After that, a reaction was performed at 60° C. for 1 hour to prepare a NCO-terminated prepolymer. Next, 2-hydroxyethyl acrylate (HEA) was added such that a molar ratio of OH of HEA to NCO of the NCO-terminated prepolymer was 1.05, and a reaction was performed at 60° C. for 1 hour to obtain urethane acrylate (B-1). In the urethane acrylate (B-1), Mn was 3200, and Mw was 3800.

### (Z-1)

A reaction was performed between polypropylene glycol with Mn of 3000 (manufactured by Sanyo Chemical Industries, Ltd., product name “PP-3000”) and TDI such that NCO/OH was 1.5 to prepare a NCO-terminated prepolymer. As a catalyst, 200 ppm of dibutyl tin dilaurate was added with respect to the final total preparation amount, and as a polymerization inhibitor, 500 ppm of BHT was added with respect to the final total preparation amount. Next, methanol was added such that a molar ratio (MeOH/NCO) of OH of the methanol to NCO of the NCO-terminated prepolymer was 0.2, HEA was added such that a molar ratio of OH of HEA was 0.85, and a reaction was performed at 60° C. for 1 hour to obtain urethane acrylate (Z-1). In the urethane acrylate (Z-1), Mn was 13100, and Mw was 17700.

Mn of the polypropylene glycol is a value obtained from a hydroxyl value. Mn and Mw of the urethane acrylate was measured by using an ACQUITY APC RI system, manufactured by Waters Corporation, in a condition of sample concentration: 0.2% by mass of a THE solution, injection amount: 20 μL, sample temperature: 15° C., mobile phase: THF, XT column for organic solvent: particle diameter of 2.5 μm, pore size of 450 angstroms, column inner diameter of 4.6×column length of 150 mm+particle diameter of 2.5 μm, pore size of 125 angstroms, column inner diameter of 4.6×column length of 150 mm+particle diameter of 1.7 μm, pore size of 45 angstroms, column inner diameter of 4.6×column length of 150 mm, column temperature: 40° C., and flow rate: 0.8 mL/minute.

As urethane acrylate (A), the following urethane acrylate was prepared.

Urethane acrylate (A-1): SARBIO 7302NS (biomass degree: 44%, Mn: 3100, Mw: 5000, Tg: 68° C., and number of functional groups: 3), manufactured by Arkema S.A.

Urethane acrylate (A-2): UFB-0146 (biomass degree: 47%, Mn: 4100, Mw: 5400, Tg: 54° C., and number of functional groups: 2), manufactured by Kyoeisha Chemical Co., Ltd.

As a monomer derived from a plant component, the following monomer was prepared.
LA: lauryl acrylate (biomass degree: 70%)
IBXA: isobornyl acrylate (biomass degree: 66%)
NOAA: n-octyl acrylate (biomass degree: 61%)
THFA: tetrahydrofurfuryl acrylate (biomass degree: 54%)
DDA: decanediol diacrylate (manufactured by Arkema S.A., product name “SARBIO 5201NS”, biomass degree: 50%)
GLDA: glycerine diacrylate (manufactured by TOAGOSEI CO., LTD., product name “ARONIX M-920”, biomass degree: 45%)
GLTA: glycerine triacrylate (manufactured by TOAGOSEI CO., LTD., product name “ARONIX M-930”, biomass degree: 37%)
GLPOTA: glycerine PO-modified triacrylate (manufactured by Arkema S.A., product name “SARBIO 5300NS”, biomass degree: 21%)

As a monomer derived from a petroleum component, phenoxyethyl acrylate (PEA), tripropylene glycol diacrylate (TPGDA), and bisphenol A epoxy di(meth)acrylate (BisAEA) (manufactured by OSAKA ORGANIC CHEMICAL INDUSTRY LTD., product name “VISCOAT #540”) were prepared. As a photopolymerization initiator, Omnirad TPO and Omnirad 184 were prepared.

### [Resin Composition for Secondary Coating]

The urethane acrylate, the monomer, and the photopolymerization initiator were mixed at a blending amount (parts by mass) shown in Table 1 to produce a resin composition for secondary coating of each Test Example. The biomass degree of the resin composition was calculated from the biomass degree of each raw material. Test Examples 1 to 11 correspond to Examples, and Test Examples 12 to 14 correspond to Comparative Examples.

### [Resin Film]

The resin composition was applied onto a polyethylene terephthalate (PET) film using a spin coater, and then, cured by using an electrodeless UV lamp system (D Bulb, manufactured by Heraeus Group) in a condition of 100 mJ/cm² and 100 mW/cm² to form a resin film with a thickness of 200 μm on the PET film. The resin film was obtained by being peeled from the PET film.

### (Young's Modulus)

The resin film was punched out into the shape of a dumbbell of JIS K 7127 Type 5, and pulled out using a tension tester in a condition of 23±2° C. and 50±10% RH and in a condition of a tension rate of 1 mm/minute and a marked line-to-marked line distance of 25 mm to obtain a stress-strain curve. A stress obtained by a secant equation at a strain of 2.5% was divided by the cross-sectional area of the resin film to obtain the Young's modulus of the resin film.

### (Glass Transition Temperature)

The resin film was punched out into the shape of a strip with a width of 6 mm, dynamic viscoelasticity was measured by using “RSA-G2”, manufactured by TA Instruments, in a condition of a tension mode (marked line-to-marked line distance: 25 mm), a frequency of 11 Hz, a temperature increase rate of 5° C./minute, and a temperature range of 25 to 150° C., and the peak top temperature of tan δ was obtained as Tg.

### [Resin Composition for Primary Coating]

75 parts by mass of the urethane acrylate (Z-1), 18 parts by mass of nonyl phenol polyethylene glycol acrylate (manufactured by Miwon Specialty Chemical Co., Ltd., product name “Miramer M164”), 5 parts by mass of N-vinyl caprolactam, 1 part by mass of Omnirad TPO, and 1 part by mass of 3-acryloxypropyl trimethoxysilane were mixed to obtain a resin composition for primary coating.

### [Optical Fiber]

Each of the resin composition for primary coating and the resin composition for secondary coating was applied to the outer circumferential surface of the glass fiber 13 with a diameter of 125 μm. Next, each of the resin compositions was cured by ultraviolet irradiation to form the coating resin layer 16 including the primary resin layer 14 and the secondary resin layer 15, and the optical fiber 10 was produced. By setting the thickness of the primary resin layer 14 to 35 μm, and the thickness of the secondary resin layer 15 to 25 μm, an optical fiber with an outer diameter of 245 μm was obtained.

### (Low-Temperature Characteristic)

A single layer of the optical fiber was wound around a glass bobbin at a tension of 50 g, and the transmission characteristic of signal light with a wavelength of 1550 nm was measured in a temperature condition of each of 23 and −40° C. to obtain a transmission loss. A case where a transmission loss difference obtained by subtracting the transmission loss at 23° C. from the transmission loss at −40° C. was 0.01 dB or less was evaluated as “A”, and a case where the transmission loss difference was greater than 0.01 dB/km was evaluated as “B”.

(Appearance after Screening Test)

A screening tension of 1.5 kg was applied to 1000 km of the optical fiber, and the optical fiber was rewound, and then, whether there was an attachment derived from the secondary resin layer on a belt of a production line was checked. A case where there was no attachment was evaluated as “A”, and a case where there is an attachment was evaluated as “B”.

TABLE 1

| | Biomass | Test Example | | | | | | | | | | | | | |
|---|---|---|---|---|---|---|---|---|---|---|---|---|---|---|---|
| | degree (%) | 1 | 2 | 3 | 4 | 5 | 6 | 7 | 8 | 9 | 10 | 11 | 12 | 13 | 14 |
| A-1 | 44 | 70 | — | — | — | — | — | — | — | — | — | — | — | — | — |
| A-2 | 47 | — | 50 | 50 | 50 | 30 | 30 | 30 | 30 | 30 | 30 | 30 | — | — | — |
| B-1 | 0 | — | — | — | — | — | — | — | — | — | — | — | 30 | 30 | 30 |
| LA | 70 | — | — | — | — | 10 | — | — | — | — | — | — | — | — | 20 |
| IBXA | 66 | — | — | — | — | — | — | — | 5 | — | — | — | — | 20 | — |
| NOAA | 61 | — | — | — | — | — | 10 | — | — | — | — | — | — | — | — |
| THFA | 54 | — | — | — | — | — | — | 10 | — | — | — | — | — | — | — |
| DDA | 50 | 28 | — | — | — | 28 | 28 | 28 | 33 | 38 | 28 | — | — | — | — |
| GLDA | 45 | — | 48 | 45 | 45 | — | — | — | — | — | — | — | — | — | — |
| GLTA | 37 | — | — | 3 | — | — | — | — | — | — | — | — | — | — | — |
| GLPOTA | 21 | — | — | — | 3 | — | — | — | — | — | — | — | — | — | — |
| PEA | 0 | — | — | — | — | — | — | — | — | — | 10 | — | — | — | — |
| TPGDA | 0 | — | — | — | — | — | — | — | — | — | — | 38 | 38 | 28 | 28 |
| BisAEA | 0 | — | — | — | — | 30 | 30 | 30 | 30 | 30 | 30 | 30 | 30 | 30 | 40 |
| Omnirad TPO | 0 | 1 | 1 | 1 | 1 | 1 | 1 | 1 | 1 | 1 | 1 | 1 | 1 | 1 | 1 |
| Omnirad 184 | 0 | 1 | 1 | 1 | 1 | 1 | 1 | 1 | 1 | 1 | 1 | 1 | 1 | 1 | 1 |

| | | | | | | | | | | | | | | |
|---|---|---|---|---|---|---|---|---|---|---|---|---|---|---|
| Biomass degree (%) | 45 | 45 | 45 | 44 | 35 | 34 | 34 | 34 | 33 | 28 | 14 | 0 | 13 | 14 |
| Young's modulus (MPa) | 1160 | 760 | 890 | 820 | 730 | 790 | 970 | 1010 | 950 | 900 | 1050 | 1000 | 1100 | 570 |
| Tg (° C.) | 94 | 68 | 76 | 73 | 81 | 82 | 88 | 98 | 95 | 85 | 85 | 85 | 111 | 75 |
| Low-temperature characteristic | A | A | A | A | A | A | A | A | A | A | A | A | B | A |
| Appearance | A | A | A | A | A | A | A | A | A | A | A | A | A | B |

### REFERENCE SIGNS LIST

10, 10A: optical fiber
11: core
12: clad
13: glass fiber
14: primary resin layer
15: secondary resin layer
16: coating resin layer
20: connected portion
21: unconnected portion
40: connecting resin layer
60, 70: optical fiber cable
61: tube
62: intervention
63, 73: tension member
64, 75: external coat
65: tear string
71: slot
72: slot rod
74: wrapping tape
100, 100A, 100B: optical fiber ribbon
D1: diameter
D2: outer diameter
F: center-to-center distance
T: thickness.

What is claimed is:

1. A resin composition for secondary coating of an optical fiber, comprising:
a photopolymerizable compound containing urethane (meth)acrylate derived from a plant component; and
a photopolymerization initiator.

2. The resin composition according to claim 1, wherein a biomass degree of the urethane (meth)acrylate is 20% or more and 70% or less.

3. The resin composition according to claim 1, wherein a content of the urethane (meth)acrylate is 10 parts by mass or more and 80 parts by mass or less on the basis of a total amount of 100 parts by mass of the resin composition.

4. The resin composition according to claim 1, wherein the photopolymerizable compound further contains a monomer derived from a plant component.

5. The resin composition according to claim 4, wherein the monomer derived from a plant component is at least one type selected from the group consisting of n-octyl (meth)acrylate, lauryl (meth)acrylate, isobornyl (meth)acrylate, tetrahydrofurfuryl (meth)acrylate, glycerine di(meth)acrylate, decanediol di(meth)acrylate, glycerine propylene oxide-modified tri(meth)acrylate, and glycerine tri(meth)acrylate.

6. The resin composition according to claim 1, wherein a biomass degree of the resin composition is 10% or more and 50% or less.

7. The resin composition according to claim 1, wherein a glass transition temperature of a resin film when curing the resin composition with an ultraviolet ray in a condition of an integrated light intensity of 100 mJ/cm² and an illumination of 100 mW/cm² is 60° C. or higher and 100° C. or lower.

8. The resin composition according to claim 7, wherein a Young's modulus of the resin film is 600 MPa or more and 2000 MPa or less at 23° C.

9. An optical fiber, comprising:
a glass fiber including a core and a clad;
a primary resin layer covering the glass fiber in contact with the glass fiber; and
a secondary resin layer covering the primary resin layer,
wherein the secondary resin layer contains a cured product of the resin composition according to claim 1.

10. A method for producing an optical fiber, comprising:
an applying step of applying the resin composition according to claim 1 to an outer circumference of a glass fiber including a core and a clad; and
a curing step of curing the resin composition by ultraviolet irradiation after the applying step.

11. An optical fiber ribbon in which a plurality of the optical fibers according to claim 9 are arranged in parallel and coated with a ribbon resin.

12. An optical fiber cable in which the optical fiber ribbon according to claim 11 is stored in a cable.

13. An optical fiber cable in which a plurality of the optical fibers according to claim 9 are stored in a cable.
